(19) United States
(12) Patent Application Publication
(10) Pub. No.: US 2005/0193046 A1
(43) Pub. Date: Sep. 1, 2005

(54) Area efficient realization of coefficient architecture for bit-serial fir, IIR filters and combinational/sequential logic structure with zero latency clock output

(75) Inventors: Rakesh Malik, Uttar Pradesh (IN); Puneet Goel, Punjab (IN)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics Asia Pacific Pte Ltd., Singapore (SG)

(21) Appl. No.: 10/968,822

(22) Filed: Oct. 21, 2004

Related U.S. Application Data
(63) Continuation of application No. 09/807,498, filed on Jun. 11, 2001, now abandoned.

(51) Int. Cl. G06F 17/10

(52) U.S. Cl. 708/300

(57) ABSTRACT

An area-efficient realization of a coefficient block [A] or architecture [A] with hardware sharing techniques and optimizations applied to this block. The block [A] is connected to coefficient lines coming from block [E] and/or [F], to be connected to perform filtering operation or a mathematical computing operation with optimization in hardware and to provide a zero latency output. Also provided is area minimal realization of digital filters based on coefficient block [A] when operated in bit serial fashion. The optimization techniques and structure applicable to linear digital filters typically a finite impulse response filter, infinite impulse response filter and for other filters and applications based on combinational logic consisting of a delay element, a multiplier, an adder and a subtractor.

### BACKGROUND OF THE INVENTION

Field of the Invention

The invention relates to area efficient realization of coefficient block [A] or architecture [A] with hardware sharing techniques and optimizations applied to this block. The optimization techniques and structure of the present invention have application in linear digital filters typically a finite impulse response(FIR) filter, infinite impulse response filter(IIR) and for other filters and applications based on combinational logic consisting of delay element(T), multiplier(M), adder(SA) and subtractor(SS).

Explanation of Elements and Symbols Used Herein

The basic component symbol used herein are shown in FIG. 2 of the drawings. In addition, explanation and usages of the device are set forth in the text below and are depicted in FIG. 3 and FIG. 4 of the drawings.

Unit delay (T)

This element is a one bit delay element. It also performs the function of a multiplier by a factor of 2. For the serial input frame, 0101011 in binary or 43 in integer representation, the output of this block is 01010110 in binary or 86 in integer representation. This element is usually a Flip-flop (D Flip-flop, J-K Flip-flop, etc.).

Fuller Adder (FA)

The full adder performs binary addition. The inputs to this element are A, B, and Cin (Carryin), while the outputs are Z and Cout (Carryout). The truth table for full adder functionality is shown in FIG. 3 of the drawings.

Full Subtractor (FS)

This element performs binary subtraction. The inputs to this element are A, B, and Cin (Carryin) while the outputs are Z and Cout (Carryout). The truth table for full subtractor functionality is shown in FIG. 3 of the drawings.

Serial Adder (SA) and Serial Subtractor (SS)

These elements perform addition and subtraction of a two serial frame, x1(nT), x2(nT) to generate output y(nT) represented as x1(nT)+x2(nT) or x1(nT)−x2(nT). The serial adder (or subtractor) is implemented using a full adder (or subtractor) with a Flip-Flop as shown in FIG. 3 of the drawings. The output Cout of [FA/FS] is delayed using the [T] element and is applied to Cin line of [FA/FS]. This enables the [FA/FS] and [T] together to function as serial adder (SA/SS), where A, B are the inputs to this element and Z is the output. (e.g., of serial addition is as follows, if x1(nT)=0110 (6 in integer) and x2(nT)=0111 (7 in integer). Then y(nT)-01101 (13 in integer representation).

Serial Multiplier (M)

The multiplier multiplies two serial input frames X(nT) and m. The output is a function represented as Y(nT)=X(nT)*m. A serial coefficient multiplier (M) can be implemented by a shift register using [T] elements and an adder element [SA] (One shift means multiply by factor of 2). As shown in FIG. 3 of the drawings, the multiplier is formed by adding the outputs corresponding to ones in the binary representation of the coefficient.

Delay (Z⁻¹)

Delay by one frame of data is done by a shift register (series of Flip-flops (T) connected to store and shift the input frame). The number of Unit delay (T) in one delay element is equal to the frame size of the input.

Existing Implementation of Filter

The following description discusses the elements used for implementation of the design and the existing implementations for digital filters. The proposed minimization is extendable to other applications such as Digital Signal Processing field and Digital designs.

The following description of the preferred embodiment, namely a FIR filter, is extendable to other filters as described earlier. FIG. 4 shows the existing structure of a bit serial FIR filter with coefficient lines CLin_{—}0, CLin_{—}1, . . . CLin_n and the coefficient block [A] having the coefficients c(0), c(1), c(2), . . . c(n). The coefficient block is connected to delay element [Z⁻¹] and serial adders [SA] to form a filter structure.

Stating the FIR filter equation in time and frequency domain

$$Y ( n ) = c ( 0 ) X ( n ) + c ( 1 ) X ( n - 1 ) + c ( 2 ) X ( n - 2 ) + … c ( n ) X ( 0 )$$

$$Y ( z ) = X ( z ) [ c ( 0 ) + c ( 1 ) {Z}^{- 1 } + c ( 2 ) {Z}^{- 2} + C ( 3 ) {Z}^{- 3} + c ( 4 ) {Z}^{- 4} + c ( 5 ) {Z}^{- 5} + c ( 6 ) {Z}^{- 6} + … c ( n ) {Z}^{- n} ]$$

where X, Y are the input and output respectively, c(0), c(1), . . . c(n) represent the coefficient values that define the characteristics of the filter, and each delay [Z⁻¹] block represents one sample delay. The filter equation can be implemented in two ways as shown in FIG. 4 of the drawings.

In implementation 1, coefficient lines CLin_{—}0, CLin_{—}1, . . . CLin_n are common and connected to input X[n]. The output lines CLout_{—}0, CLout_{—}1, . . . CLout_n are connected to block [E], consisting of delay element [Z-1] and serial adders [SA] elements. The structure enables easy realization of a shareable multiplier in the coefficient block [A]. An example of a shareable multiplier with coefficient values 3,11 is illustrated in FIG. 4. The realization of these coefficients separately would require 4[T] and 3[SA] elements. By virtue of CLin_{—}0, CLin_{—}1, . . . being common, the hardware is realized using 3[T] and 2[SA] elements. Another feature of the structure is that the structure inherently requires more storage area, represented by [Z⁻¹], as compared to implementation 2, since the storage is done after the multiplications. For an input frame of n bit and a coefficient of size of m bit, the storage area of each delay element [Z⁻¹] is (m+n). The total storage space of the delay elements is (m+n)*(number of coefficients −1). In implementation 2, the coefficient line CLin_{—}0, CLin_{—}1, . . . are not common. By virtue of connectivity of different input lines to the coefficient elements [c(0), c(1) . . . ], the realization of coefficient block [A] using shareable elements is not present. Another feature of this structure is that it inherently requires lesser storage space, represented as [Z⁻¹], because unlike the previous implementation, the storage is done before multiplication. For an input frame of m bit and a coefficient of size n bit, the storage area of each delay element [Z⁻¹] is (m). The total storage space is (m)*(number of coefficients −1).

### BRIEF SUMMARY OF THE INVENTION

The embodiments of the invention reduce the hardware of the coefficient block [A] by having shareable elements in coefficients, even if the coefficient lines CLin_{—}0, CLin_{—}1, . . . are not commonly connected. For the existing configuration shown in FIG. 7 and FIG. 8, the shareability of hardware in block [A] is a limitation.

Also, as described in the previous section, implementation 2 is area efficient with respect to implementation 1 due to reduced sizes of the delay elements. Over and above this by having a shareable multiplier or reduced coefficient block [A], implementation 2 becomes still more area efficient. This reduction is extendable to other filters based on the coefficient block [A] as stated in the first section. The present invention operates on integer-valued coefficients.

Further, to quote Norsworthy and Crochiere (Delta-Sigma Data Converters IEEE press pp-435, Copyright 1997):

“Bit-serial architecture reduce the interprocessor communication down to 1 bit. Generally the number of processors is very large, but because each processor is so small, the overall economy is very high. Bit serial architectures are usually most effective for filters having a few state variables, such as IIR filters and the wave-digital filters. For this reason, bit-serial techniques are less frequently applied to FIR structures, especially when the filter length is relatively long . . . ”

However, the present invention applies optimization techniques for reducing the area in large sized coefficients by applying a number of optimizations in FIR/IIR filter structures.

To elaborate the optimization techniques of the present invention, consider an FIR filter with symmetrical coefficient as 5, 14, 25, 30, 25, 14, and 5. Though the size of the coefficients in this example is small, it is enough to elaborate the minimization proposals. Stating the FIR filter equation in time and frequency domain

$$Y ( n ) = c ( 0 ) X ( n ) + c ( 1 ) X ( n - 1 ) + c ( 2 ) X ( n - 2 ) + … c ( n ) X ( 0 )$$

$$Y ( z ) = X ( z ) [ c ( 0 ) + c ( 1 ) {Z}^{- 1 } + c ( 2 ) {Z}^{- 2} + C ( 3 ) {Z}^{- 3} + c ( 4 ) {Z}^{- 4} + c ( 5 ) {Z}^{- 5} + c ( 6 ) {Z}^{- 6} + … c ( n ) {Z}^{- n} ]$$

where X, Y are the input and output respectively and c(0), c(1). . . c(n) represent the coefficients value.

Using the coefficient values in the above equation
Y(n)=5X(n)+14X(n−1)+25X(n−2)+30X(n03)+25X(n−4)+14X(n−5)+5X(n−6)
Y(z)=X(z)[5+14Z⁻¹+25Z⁻²30Z⁻³+25Z⁻⁴+14Z⁻⁵+5Z⁻⁶] (EQ 1)
The Existing Method and Minimization

FIG. 5 shows the FIR filter structure of implementation 2. This illustrates the realization of an FIR filter represented by Equation 1.

In one known optimization technique, advantage is taken of the symmetry in the coefficients. The streams which have to be multiplied with the same coefficients can be added first and then multiplied. For a large filter structure, this leads to a reduction by 45% in the coefficient block. (See FIG. 6 of the accompanying drawings.)

This is done by restructuring the equation as follows:
Y(z)=X(z)[5*(1+Z⁻⁶)+14*(Z⁻¹+Z⁻⁵)+25*(Z²+Z⁻⁴)+30*Z⁻³] (EQ 2)

For the rest of the optimization proposals, the description will focus on the multiplier adder series, which is shown in the dotted box referred to as coefficient block [A]. FIG. 7 of the drawings shows the traditional way of implementation of the example structure for block [A], wherein S1 to S4 represent the lines connected to delay block [Z-1] through line CLin_{—}0 to CLin_{—}6 depicted in FIG. 6 of the drawings. The Lines S1 to S4 are separately connected to the [T] element for performing a multiplication by a factor of 2, and (SA) is used to perform serial addition of data. This represents the multiplier less the realization of the filter coefficient block [A] where the property of the flip-flop (T) as multiplier of two is used.

Mathematically, the restructured equation according to the structure is stated as:
Y(nT)=(4+1)S1+(8+4+2)S2+(16+8+1)S3+(16+8+4+2)S4 (EQ 3)
In this implementation, the lines S1, S2, S3, S4 are not commonly connected. Hence, this restricts achieving a shareable hardware in the coefficient block [A]. Thus all the function/operations of this block represent unique hardware. The elements required by the terms are listed as:
First term =2[T], 1[SA] elements;
Second term=3[T], 2[SA] elements;
Third term=4[T], 2[SA] elements;
Fourth term=4[T], 3[SA] elements; and
Final addition of all the four terms would require 3[SA] elements.

The generalized structure of The Existing Method and Minimization is depicted in FIG. 8. In the structure, each column represents a coefficient value. The [T] elements, shown as T1_{—}1 to T1_m in column 1, define connectivity with line S1. In a similar fashion, [T] elements, shown as Tn_{—}1 to Tn_m in column n, define the connectivity with line Sn.

The presence of one of the elements in columns 1 to n (i.e., T1_{—}1 to T1_m, T2_{—}1 to T2_m . . . Tn_{—}1 to Tn_m) is determined by coefficient value. Thus depending on the coefficient value on lines S1 to Sn, the number of [T] element in a column is determined. Also the number of serial adders/subtractor [SA/SS] in the columns is represented as (SA1_{—}1 to SA1_m,SA2_{—}1 to SA2_m . . . SAn_{—}1 to SAn_m). The presence of one of these elements is again defined by the coefficient value.

In the structure, the [T] elements are arranged in shift register form. The input to the first [T] element is connected to one of the S lines, while the input to [SA/SS] is connected from input S* and/or one of the output of the [T] elements of shift register, depending on the coefficient value. Finally, using SAe_{—}1 to SAe_n−1 elements, the addition/subtraction of [SA/SS] of all the coefficient terms depicted in the columns is done. The final output is the output of last addition/subtraction [SA/SS].

Among the lines S1 to Sn, the [T] elements are not shareable and also the [SA] in each column are also not shareable. Thus limited minimization is possible in this structure.

The disclosed embodiments of the invention are directed to a co-efficient processing circuit for processing combinational logic coefficients, such as those used in digital filters, in a bit serial format having n bit positions. In one embodiment the circuit includes a plurality of serial input bit lines carrying coefficient signals; a combinational-sequential circuit, ideally made up of a plurality of serial adder blocks corresponding to the number of bit positions, each serial adder block comprising at least one serial adder and coupled to at least one of the plurality of serial input bit lines and including an output; and an output block coupled to the combinational-sequential circuit and configured to receive the output of each serial adder block, the output block comprising n−1 multiplier circuits, preferably multiplier-by-two circuits composed of flip-flops, for bit positions 0 through n−1, each multiplier circuit having an input coupled to an output of each respective serial-adder block in the corresponding bit position, the multiplier circuit in each bit position 0 to n−1 having an output coupled to an input of the serial adder block occupying the next higher bit position, and the output of the serial adder block in the n bit position comprising an output of the circuit.

In accordance with another aspect of the foregoing embodiment, the serial adder blocks comprise at least one serial adder, and the at least one serial adder block includes at least one serial subtractor.

In accordance with another embodiment of the invention, a coefficient processing circuit for processing combinational logic coefficients in a bit serial format having five bit positions is provided. The circuit includes first, second, third, and fourth serial input lines carrying respective coefficient signals; a combinational-sequential circuit comprising first, second, third, fourth, and fifth serial adder blocks corresponding to bit positions 0 through 4, respectively, each of the serial adder blocks coupled to at least two of the serial input lines; and an output circuit coupled to the combinational-sequential circuit and comprising first, second, third, and fourth multiplier circuits, each multiplier circuit having an input coupled to an output of the respective serial adder block and corresponding to bit positions 0 through 3, and each multiplier circuit having an output coupled to the serial adder block occupying the next higher bit position, the output of the fifth serial adder block comprising an output of the circuit.

### BRIEF DESCRIPTION OF THE SEVERAL VIEWS OF THE DRAWINGS

In the accompanying drawings:

FIG. 1 shows the field of invention, applications of the device

FIG. 2 shows the symbol of components used in device.

FIG. 3 shows the description of the components used in device.

FIG. 4 shows the bit serial FIR filter implementations.

FIG. 5 shows an example of FIR filter.

FIG. 6 shows one of the known minimization technique due to symmetry of coefficient.

FIG. 7 shows the structure of existing/known implementation technique for example FIR filter.

FIG. 8 shows the generalized structure of existing/known implementation technique of coefficient block.

FIG. 9 shows a realization of the coefficient block for coefficient value close to power of two.

FIG. 10 shows the optimization (a) for realizing the coefficient block for example FIR filter, of the present invention.

FIG. 11 shows the optimization (b) for realizing the coefficient block for example FIR filter, of the present invention.

FIG. 12 shows the optimization (c) for realizing the coefficient block for example FIR filter, of the present invention.

FIG. 13 shows the generalized optimized structure, of the present invention.

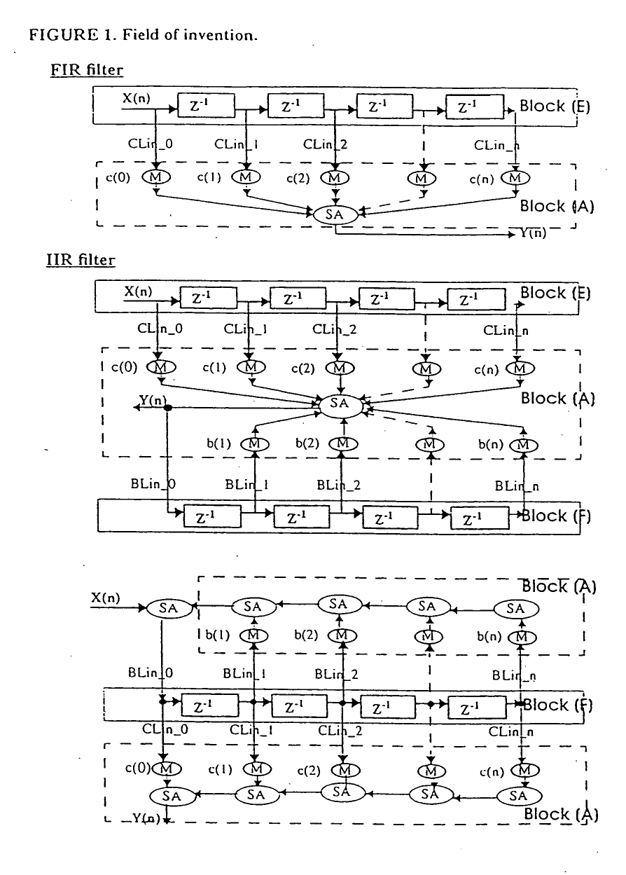

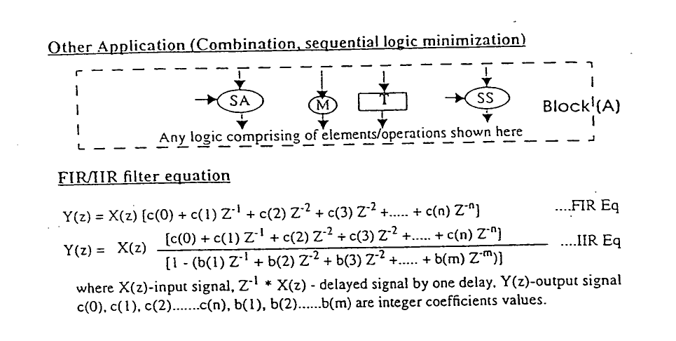

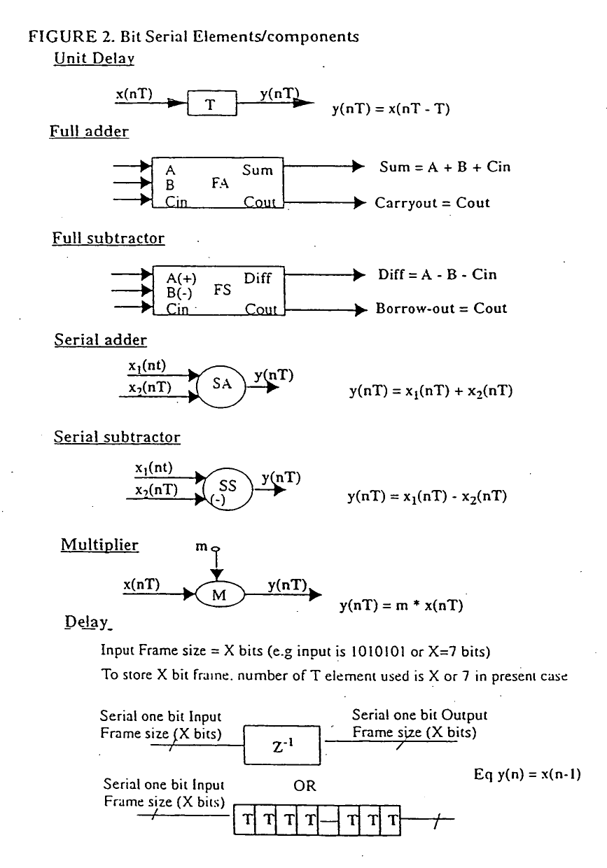

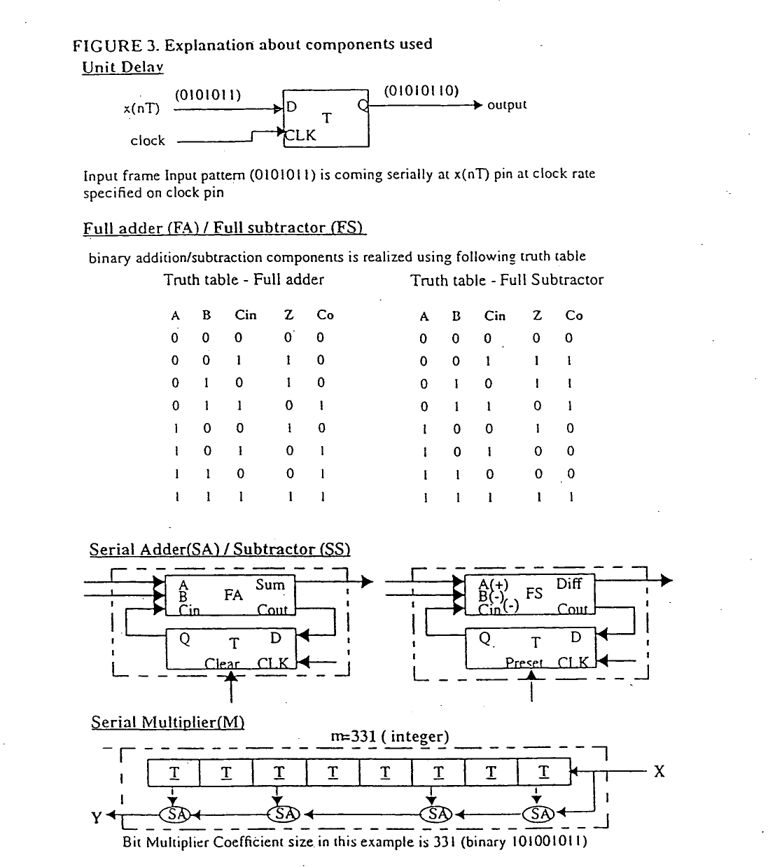

### DETAILED DESCRIPTION OF THE INVENTION

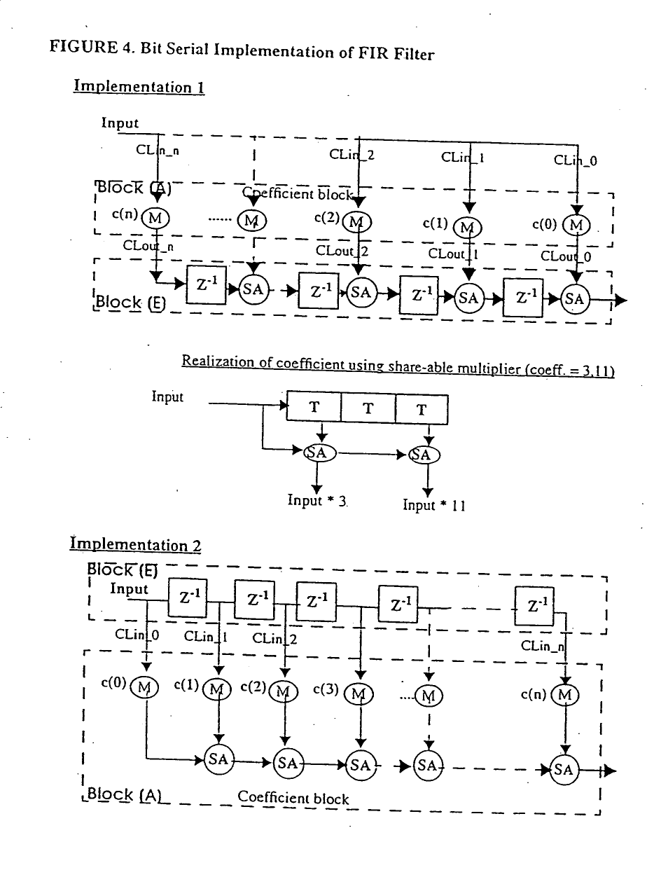

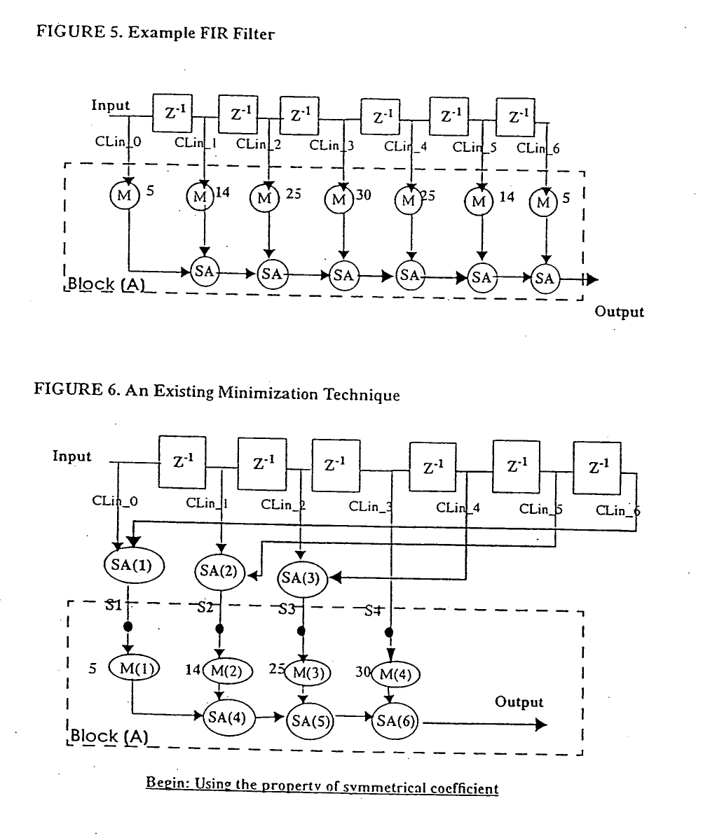

The device in accordance with one embodiment of the invention reduces the hardware of the coefficient block [A] by having shareable elements in the coefficient block [A], even in the implementation where the coefficient lines CLin_{—}0, CLin_{—}1, . . . are not commonly connected (shown as architecture [A]). This reduced hardware in the coefficient block when applied implementation 2 (FIG. 4) and makes it still more area efficient. This reduction is extendable to other filters based on coefficient block [A], as stated in the first section.

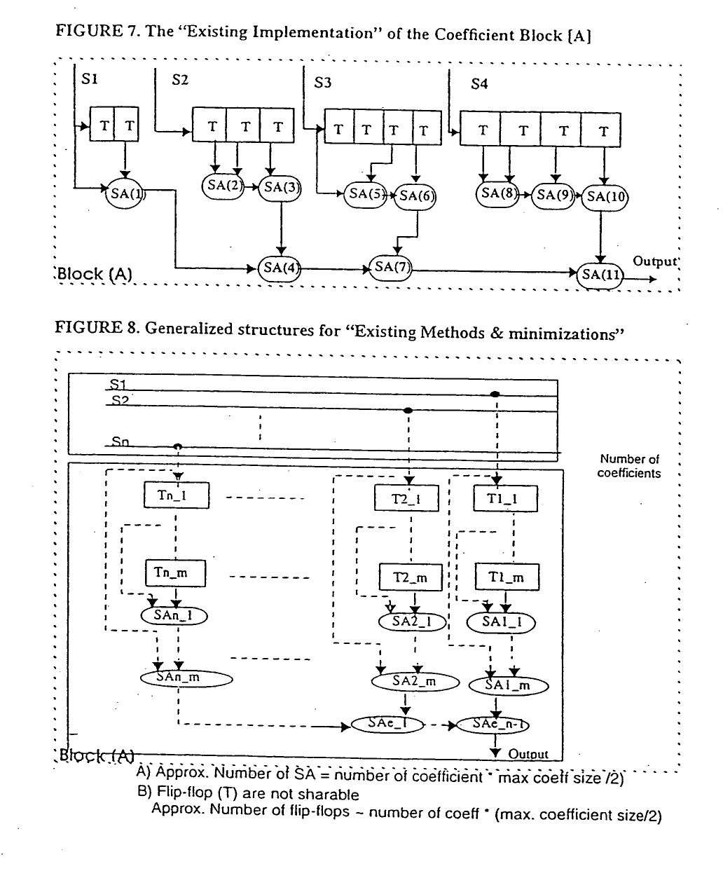

The device of the present invention reduces the area by approximately 30-50% of that shown in FIG. 7 by reducing the number of components. The optimization techniques are illustrated mathematically and towards the end of this section where a generalized equation and structure of the device is presented.

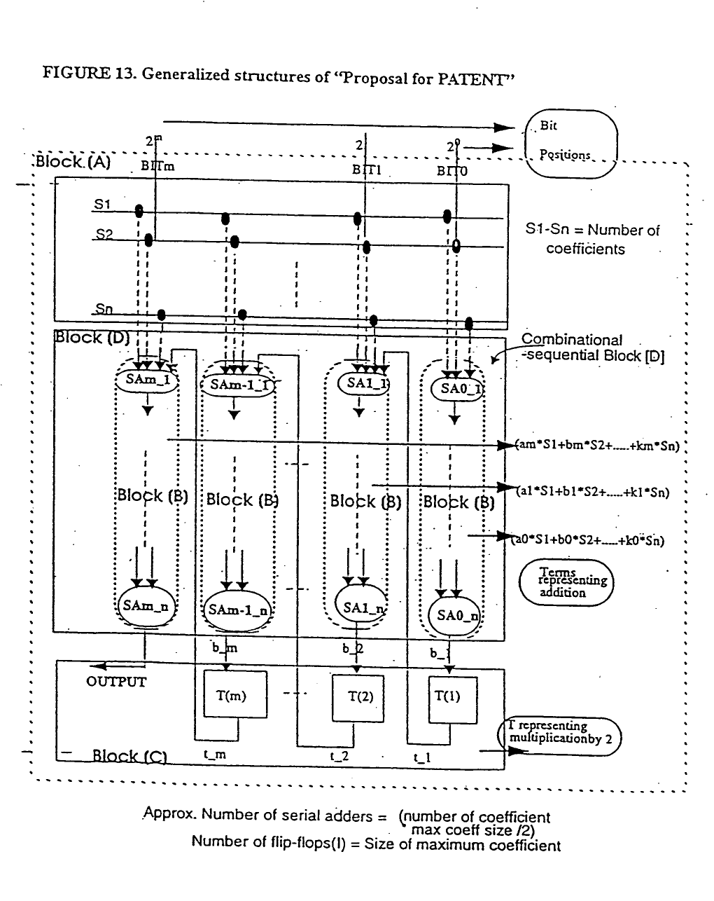

Accordingly, an embodiment of the present invention illustrated in FIG. 13 represents a device for providing an area efficient realization of the coefficient, said device comprised of architecture [A] with hardware sharing techniques and optimization applied to this architecture. The architecture [A] is connected to coefficient lines CLin_{—}0, CLin_{—}1 . . . CLin_n and/or BLin_{—}0, BLin_{—}1, . . . . BLin_n coming from block [E] and/or [F], to be connected to perform filtering operation or a mathematical computing operation with optimization in hardware and provides a zero latency output, the said architecture [A] has serial input bit lines as S1, S2 . . . Sn [where n represents the number of coefficients of the filter] and the addition terms of the equation
[(a0*S1+b0*S2+ . . . +k0*Sn),
(a1*S1+b1*S2+ . . . +k1*Sn) . . . (am*S1+bm*S2+ . . . +km*Sn)]
are represented as blocks [B], the values of a0, b0, . . . etc. are represented as [(+/−)1 or 0], the said Block [B] is a combinational-sequential block consisting of serial adders (SA) & serial subtractors (SS) elements, the connection of elements (SA/SS) to S1, S2, . . . Sn lines and interconnection of the elements (SA, SS) depend on the value of coefficients, the SA/SS elements are arranged in matrix form SA0_{—}0 to SA0_n in bit position 0 and SA1_{—}1 to SA1_n in bit position 1 and similarly SAm_{—}1 to SAm_n in bit position m, the presence of one of these elements is defined by coefficient value, the output of each block [B] is connected to [T] elements through line b_{—}1, b_{—}2, . . . b_m, the number of T elements depends on the size of maximum coefficient and is share-able for all the coefficient in the coefficient architecture [A], the output of element [T] is connected to one of the inputs of combinational logic of block [B] of next bit position (i.e., connected to input of element (SA or SS) of block [B] depending upon the sign value +/−), Lines t_{—}1, t_{—}2, . . . . t_m are used to mark the interconnections from cluster [C] to [B], in the said structure [A], all the elements in the block [B] are clustered together as block [D] and all the unit delay elements {T[1], T[2] . . . T[m]} are clustered together in block [C], thereby separating the combinational-sequential and sequential logic, while the sequential elements [T] of block [C] are common for all the coefficients and are share-able and positioned at end position of each Block [B], the Block [D] has combinational-sequential element block [B] which are essentially SA, SS. In the structure the hardware within block [B] are shareable across various [B] blocks and also within block [D]. The final output is taken from the output of the elements of the last bit position.
An Embodiment of the Invention or Optimization (a)

Continuing the same example of FIR filter and using Equation 3 of the previous section:
y(nT)=5*S+14*S2+25*S3+30*S4
Y(nT)=(4+1)S1+(8+4+2)S2+(16+8+1)S3+(16+8+4+2)S4
we proceed to share the shift registers (multiply by 2) of the design:

$$= ( S3 + S4 ) * 16 + ( S2 + S3 + S4 ) * 8 + ( S1 + S2 + S4 ) * 4 + ( S2 + S4 ) * 2 + ( S1 + S3 ) \\ = ( S1 + S3 ) + 2 * ( S2 + S4 + 2 * ( S1 + S2 + S4 + 2 * ( S2 + S3 + S4 + 2 * ( S3 + S4 ) ) ) ) \qquad ( EQ 4 )$$

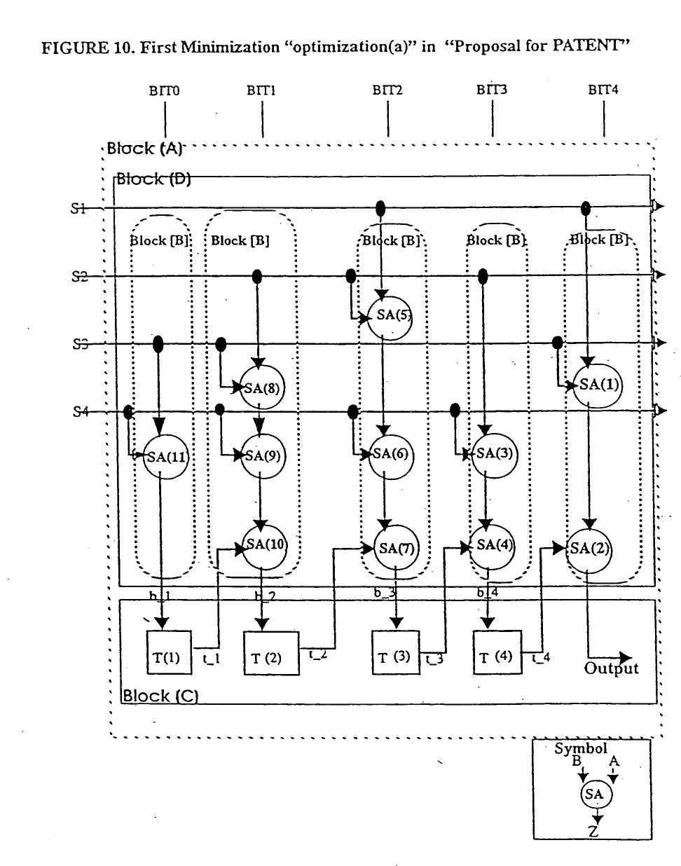

The implementation flow for this equation is presented below this text paragraph and the hardware implementation is shown in FIG. 10 of the drawings. In the flow of implementation, S1, S2, S3, S4 represents four inputs. The primary additions are done using serial adders SA(1), SA(3), SA(5), SA(8), SA(l 1) representing addition of terms S1+S3, S2+S4, S1+S2, S2+S3, S3+S4. While the secondary and tertiary additions are done using the adders SA(6), SA(9), SA(10), SA(7), SA(4), SA(2). The multiplication by factor of two is done using the elements T(1), T(2), T(3), T(4).

Implementation flow of equation {optimization (a)}

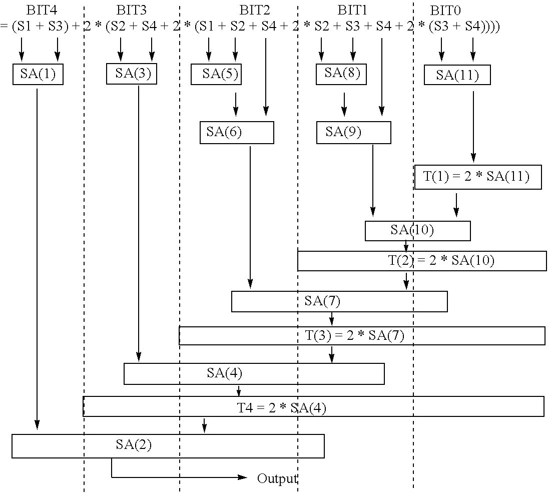

As shown in the above implementation flowchart, the equation defines the bit position as BIT0 to BIT4, which is the position of “multiplication by power of two”. (e.g., BIT0 represents multiplication by 2⁰). At BIT0 position addition of S3+S4 is performed and the output is terminated at T(1). The output of T(1) defines the next bit position BIT1, which performs addition of S2+S3+S4 and output of T(1) by using the [SA]. The output of this addition is again terminated at T(2). The structure is repeated in next BIT positions. The final addition of BIT position BIT4 gives the output of the coefficient block [A].

Implementation of hardware is shown in FIG. 10, wherein the input line S1 to S4 represent the lines connected to delay block [Z⁻¹] through coefficient line CLin 0 to CLin_{—}6 depicted in FIG. 6 of the drawings. The Lines S1 to S4 are connected to block [B] for performing the serial addition/subtraction, for which [SA], [SS] elements are used within block[B]. The input to [B] block is connected to line S1 to S4 and also from [T] elements as would be explained later in this section. The output of each block [B] is terminated with the [T] element, which represents the block [B] output being multiplied by “a factor of 2”. Each [T] elements defines bit position marked as BIT1, BIT2, BIT3, BIT4. The output b_{—}1 of block [B] which is at bit position BIT0 is fed to the input of the T(1), in turn the output line t_{—}1 of element [T(1)] is fed to next section of block[B]. The connectivity is done in similar fashion for other [T] blocks. Thus all addition/subtraction in block [B] defines a bit position before getting multiplied by “a factor of 2” and changing to next bit position. The block [B] at final bit position represents the output of the coefficient block [B].

In the structure, all [T] elements are represented as block[C] wherein the flip-flop [T] representing multiplication by a factor of 2, is share-able among various coefficient values and their number is determined by maximum coefficient value. This is in contrast to FIG. 7 of existing structure where the elements are not share-able between S1 to S4 lines.

The number of flip-flops (T) in FIG. 7 is 13 vs. the number of flip-flops(T) in the current proposal is 4. Also, for both the implementation, the number of the one-bit serial adders (SA) remains the same [11 in each case]. In present minimization, approximate area calculations is =11 serial adder +4 T=26 Units, whereas the area after previous minimization is 11 serial adder +13 T=35 units. (assuming 1 Unit =1 FA=2HA=IT and serial adder/serial subtractor (SA/SS)=2 Units). This is approximately a 26% saving in area in FIG. 10 as compared to FIG. 7.

For filter having large size coefficient, this leads to a drastic reduction in the area (30-50% of the coefficient block).

Another Embodiment of the Invention or Optimization (b)

This optimization reduces the hardware of block [D] which essentially consists of (SA) and (SS) elements. Beginning with Equation 4 and finding out the common additive factors:
A1=S2+S4
A2=S3+S4

The Equation 4 can be further reduced as:
y(nT)=(S1+S3)+2*(AI+2*(SI+A1+2*(S2+A2+2*A2))) (EQ 5)

The flow of implementation of the equation is illustrated below and is self explanatory. Here S1, S2, S3, S4 represents four inputs. The primary addition is done using serial adders SA(1), SA(3), SA(9) representing addition of terms S1+S3, S2+S4, S3+S4. While the secondary and tertiary addition is done using the adders SA(5), SA(7), SA(3), SA(6), SA(4), SA(2). The multiplication by factor of two is done using the elements T(1), T(2), T(3), T(4).

Implementation flow of equation {optimization (b)}

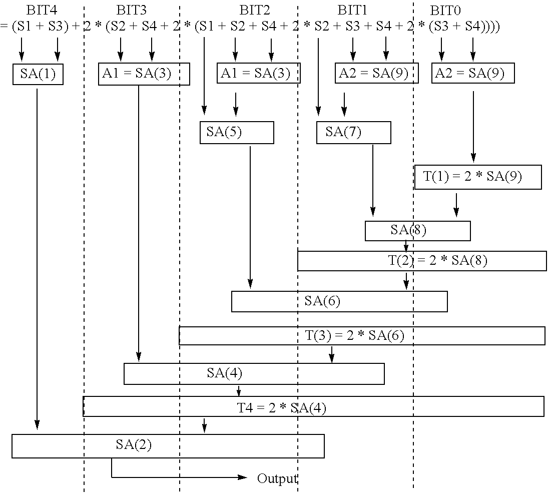

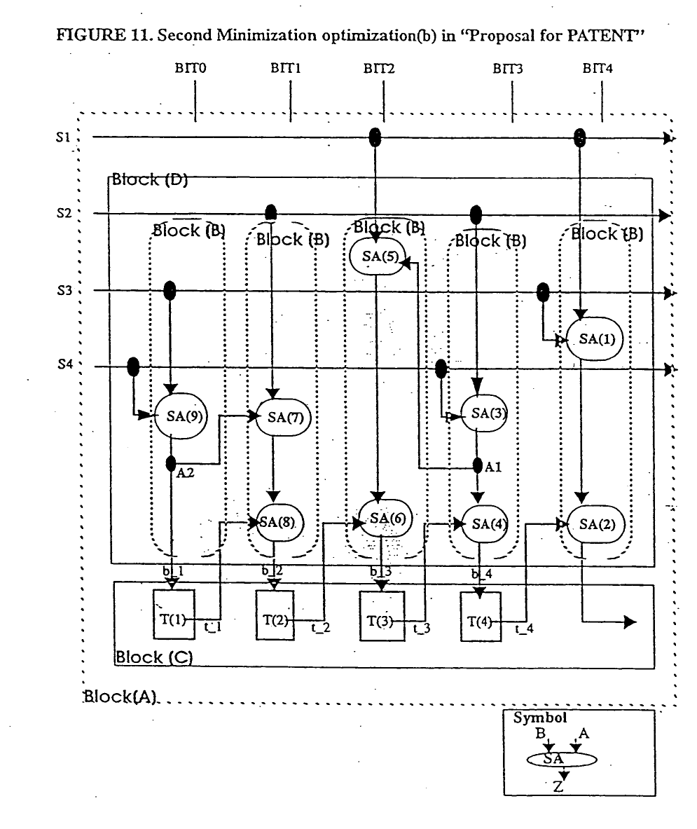

FIG. 11 shows the implementation of the structure, wherein the input line S1 to S4 represent the lines, connected to delay block [Z⁻¹] through coefficient lines Clin_{—}0 to CLin 6 depicted in FIG. 6 of the drawings. The Lines S1 to S4 are connected to block [B] for performing the serial addition/subtraction, for which (SA), (SS) elements are used within block[B]. The input to [B] block is from line S1 to S4 and also from [T] elements. The output of each block [B] is terminated with a [T] block, which represents the block [B] output being multiplied by factor of 2. The output b_{—}1 of block [B] which is at bit position BIT0, is fed to the input of the T(1), in turn the output t_{—}1 of [T(1)] is fed to next section of block[B]. Thus all addition defines a bit position before getting multiplied by factor of 2. All such [T] termination is represented by block[C].

The optimizations in reducing the hardware of block [D] are done. The output b_{—}1 representing the bit position BIT0 and addition term A2, is connected to T[1] and also fed to the next block [B], hence reducing the adder count by 1. Also the output of adders SA(3) of block [B] in bit position BIT3, is fed at two points. One to the input of adders SA(4) which eventually terminates at [T4] element and other to the input of adder SA(5), hence reducing the adder count further by 1.

Note how A1 and A2 are shared in the Structure. Comparing the hardware implementation of FIG. 10 and FIG. 11, the number of adders is minimized by having common adders A1, A2. This optimization is dependent on finding common addition terms among coefficients.

In the present minimization, approximate area calculations is 9 serial adder (SA)+4 (T)=22 Units, whereas the area of the existing minimization of FIG. 7 is 11 (SA)+13 (T)=35 units, assuming 1 Unit=1 FA=2HA=IT and serial adder (SA)=2 Units. Thus compared to the existing minimization, Optimization (a) and Optimization (b) combined have resulted in 37% saving in area (13/35*100). Optimization (b) is an improvement of 15% in area (of the coefficient block) over Optimization (a)

Yet another Embodiment of the Invention or Optimization (c)

In realization of block [D], further optimization is done by realizing the coefficient value using subtraction instead of addition. This is good for numbers that have values closer to power of 2. (e.g., for realization of coefficient value 63, the realization (63=64−1) is better than (63=32+16+8+4+2+1). In the first case the number of subtractor is 1 while in second case the number of adders are 5.

To illustrate this by an example, consider the coefficient values as 5, 25, −48, −63). Writing the FIR equation using these coefficient values.

$$Arranging the terms with 63 as ( 32 + 16 + 8 + 4 + 2 + 1 ) \\ \begin{matrix}y ( nT ) = 5 * S1 + 25 * S2 - 48 * S3 - 63 * S4 \\ = ( 1 + 4 ) * S1 + ( 16 + 8 + 1 ) * S2 \\ = ( 32 + 16 ) * S3 - ( 32 + 16 + 8 + 4 + 2 + 1 ) * S4 \\ = ( S1 + S2 + S4 ) + 2 * ( - S4 + 2 * ( S1 - S4 + 2 * \\ ( S2 - S4 + 2 * ( S2 - S4 - ( S3 + 2 ( S3 + S4 ) ) ) ) ) )\end{matrix} \qquad ( EQ 6 )$$

Alternately arranging the terms with 63 as (64-1), the first equation reduces

$$= ( 1 + 4 ) * S1 + ( 16 + 8 + 1 ) * S2 - ( 32 + 16 ) * S3 + ( 1 - 64 ) * S4 \\ = ( S1 + S2 + S4 ) + 2 * ( 2 * ( S1 + 2 * ( S2 + 2 * ( S2 - S3 - 2 * ( S3 + 2 * S4 ) ) ) ) \qquad ( EQ 7 )$$

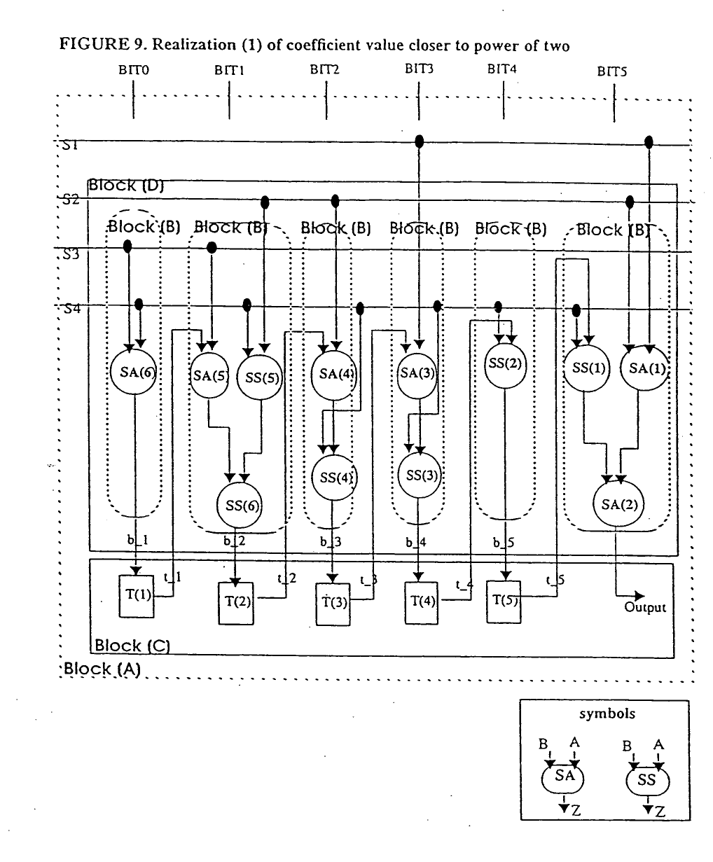

The realization of Equation 6 and Equation 7 is shown in FIG. 9 and

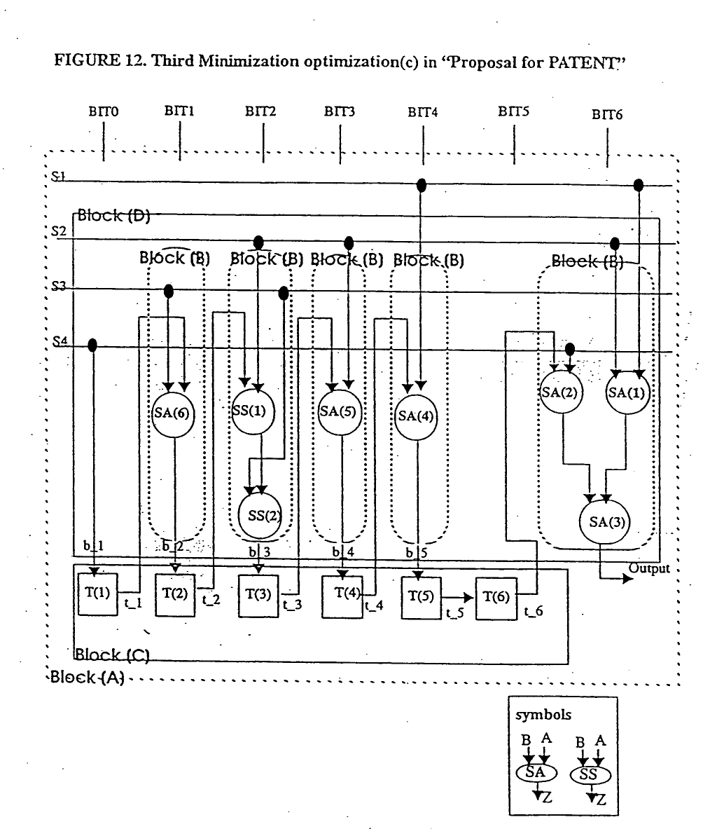

FIG. 12 respectively.

In these realizations, the number of [T] elements is one more in Equation 7 due to the presence of the term 64. However, the number of adders are less in the structure represented by Equation 7 than by Equation 6. This is because the number of adders are less in the former case. Comparing the area of the two realization, from Equation 6, the area obtained is 5 T+6 SA+6 SS=29 Units. While from Equation 7, representing optimization(c), results in an area calculation of =6T+6SA+2SS=22 Units, assuming 1 Unit=1 FA=2HA=IT and SA=SS=2 Units. This is an improvement by 24% in reducing area of coefficient block for the current example.

Thus, the optimization reduces area for realization of negative coefficient. This optimization is also efficient realization of coefficients having values close to the power of two. Further minimization is possible by taking subtraction as a common factor and using addition instead of subtraction wherever possible in the realization. This results in an improvement in area, due to the fact that area for a subtractor is more than the area of an adder.

Generalized Structure of the Invention

The invention provides an area efficient realization of filter coefficient block[A] applicable to filter devices such as FIR, IIR and other filter structures. This architecture is also applicable to combinational and sequential logic consisting of adders, subtractors, multipliers and flip flops [T]. This architecture is realized using the elements serial adders (SA), serial subtraction (SS) and flip-flop [T].

A generalized structure of the present invention is depicted in FIG. 13. The generalized equation of the structure is also calculated here.

Beginning with the generalized equation of FIR filter coefficient block(A):
y(nT)=a*S1+b*S2+c*S3+ . . . k*Sn (1)
where a, b, . . . k represents filter coefficients. S1, S2 . . . represents bit lines corresponding to the coefficients.

Now, representing each coefficient as an addition of terms arranged in power of two and applying it to the equation:
y(nT)=(2^{m}*am+ . . . 2¹*a1+2⁰*a0)* S1+(2^{m}*bm+ . . . 2¹*b1+2⁰*b0)* S2+(2^{m}*cm+ . . . 2¹*c1+2⁰*c0)* S3+ . . . +(₂m*km+ . . . 2⁻¹*k1+2⁰*k0)*Sn

Further, taking “2” as a common factor, the generalized equation for architecture is:

$$\begin{matrix}Y ( nT ) = ( a0 * S1 + b0 * S2 + … + k0 * Sn ) + \\ {2}^{1} ( ( a1 * S1 + b1 * S2 + … + k1 * Sn ) + \\ {2}^{1} ( ( a2 * S1 + b2 * S2 + … + k2 * Sn ) + \\ {2}^{1} ( ( a3 * S1 + b3 * S2 + … + k3 * Sn ) + … + \\ {2}^{1} ( ( am * S1 + bm * S2 + … + km * Sn ) ) ) ) )\end{matrix}$$

where a0, a1, . . . am and b0, b1, . . . bm and k0, k1, . . . km represents the sign of coefficients [i.e., they have value (+/−1) or 0]. The architecture realization in FIG. 13 is done using the sequential elements, such as unit delays [T] and combinational elements, such as serial adder (SA) and serial subtractor (SS). The highlights of the architecture are:
1) common shareable [T] elements for all the coefficients. The maximum number of [T] elements is equal to the next integer value of “log of the maximum value of coefficient” in the coefficient block [A]
2) Area-optimizations in reducing the combinational logic [D] (i.e., optimizations applied on serial adders(SA), serial subtractor (SS) as stated in previous section).

In FIG. 13, the input serial data is present on bit line S1, S2 . . . Sn. [where n represents the number of coefficients of the filter] The addition terms of the equation
[(a0*S1+b0*S2+ . . . . +k0*Sn),(a1*S1+b1*S2+ . . . +k1*Sn . . . (am*S1+bm*S2+ . . . +km*Sn)]
are represented as blocks [B]. Block [B] is a combinational-sequential block consisting of serial adders (SA) and serial subtractors (SS) elements. The values a0, b0 . . . etc. represent value [(+/−)1 or 0]. The connection of elements (SA/SS) to S1, S2 . . . Sn lines and interconnection of the elements (SA, SS) depend on the value of coefficients. [This is because the value of coefficient determines the value of a0, a1 . . . . . . . etc. and hence it defines the interconnections between them]. The output of each block [B] is multiplied by two using [T] elements. The elements T[l], T[2] . . . T[m] are used for multiplication by factor of 2. The number of T elements depends on the size of maximum coefficient and is share-able for all the coefficient in the coefficient block [A]. Thus in the structure the final outputs of all the blocks [B] are terminated at unit delay elements [T] (connected through b_{—}1, b_{—}2 . . . . b_m).

In the structure, all the elements [B] are clustered together as [D] and all the unit delay elements {T[1], T[2] . . . T[m]} are clustered together in [C]. The sequential [C] and combinational-sequential logic [D] are quite separated in this architecture. The input of the unit delay element [T] is final output of block [B] and the output of element [T] is connected to the one of the inputs of combinational logic of block [B] of next bit position (i.e., connected to input of element (SA or SS) of block [B] depending upon the sign value+/−). The interconnections from cluster [C] to [B] are represented as t_{—}1, t_{—}2 . . . t_m.

The bit positions of serial data frame are marked as BIT0, BIT1 . . . BITm.

In the generalized structure, flip-flops[T] of all the coefficient are shareable and the number of flip-flops[T] are limited to the coefficient that has the maximum value. Also optimization can be applied in block [D]. The gain in area when compared with the existing design is illustrated below.

Hardware Reduction in Block [C]

Before beginning to prove the statement, we proceed to formularize the calculation of the number of flip-flops (T) for structure of “The Existing Method & Minimization” in “FIG. 7” and “FIG. 8” of the drawings. The number of flip-flops in the coefficient block depends on the size of all the coefficients. The approximate and conservative formula for calculation of total flip-flops (T) in coefficient block is [average size of coefficient*number of coefficient], where average size of coefficient can be calculated pessimistically as (Maximum coefficient size/2). (Refer to the existing method and minimization, and FIG. 8 of the drawings). Applying this formula to the example of FIG. 7 for verification, where coefficients (5, 14, 25, 30) are represented in 4,5,6,6 bits (using signed notation). According to the formula, the average size of the coefficient is (6/2)=3 and the total number of flip-flops 3*4=12. This is conservative as compared to the implementation where the total number of flip-flops are 13 (refer to FIG. 7).

Similarly, the approximate formula for calculation of total adders (SA) in the coefficient block for “The Existing Method and Minimization” and “Detailed Description of the Invention” in FIG. 8 and FIG. 13 is [=adders per coefficient* number of coefficient]. Adders per coefficient solely depend on the value of the coefficient, assuming the number of adders as the number of coefficients*maximum coefficient size/2.

Now, as an example, provided herebelow is use of the above mentioned formulae from the previous two paragraphs in filter of 20 coefficient. Assume the maximum coefficient value is represented in 16 bits (e.g., maximum coefficient value is +32767 or −32768 in 2's complement representation). Average size of the coefficient approximated by the formula is 16/2=8 bit. In the existing method and minimization, the total number of flip-flop (T) required for implementation is 8*20=160. In contrast to this “Detailed Description of the Invention,” this would require only 16 Flip-Flops (the number of flip-flops of all the coefficient are share-able and are limited to the coefficient which has the maximum value). Assuming in a worst case that there is no optimization of adders, the number of adders in both the cases are the same and are equal to 8*20=160. (Refer to FIG. 8 and FIG. 13 of the drawings.)

Area calculation for the existing method and minimization as shown in FIG. 8 of the drawings is 160 T+160 SA=480. Area calculation for “Detailed Description of the Invention”, FIG. 13 is 16 T+160 SA=336. This is an improvement of 30% [(480-336)/480] over “The Existing Method and Minimization”. (assuming 1 Unit =1 FA=2HA=IT and serial adder/serial subtractor (SA/SS)=2 Units). The area gain by structure could be as high as 50% (of the coefficient block) for big filter where minimization of adders and other minimization optimization(a), optimization(b) and optimization(c), as discussed earlier, are applied.

The preferred embodiment of the invention is also supported by a real example of a filter coefficient device. This is referred to as optimization(a) and shown in FIG. 10 of the drawings and discussed in the previous section. Area calculation for FIG. 10 is 11 SA+4T=26 units while the area of FIG. 7 (existing implementation) is 11 SA+13T=35 units. This results in a gain of 26% in area (of coefficient design block) for this example design as compared to existing implementation, supporting the generalized statement.

Hardware Reduction in Block [D]

The optimizations in block [D] are referred to as optimization (b), optimization (c) and shown in FIG. 11, FIG. 12 of the drawings. In optimization (b), beside sharing the flip-flop (T) for all the coefficients and sharing the common adders (SA), techniques are done in cluster [D]. This is due to the presence of (SA), (SS) in block [D] and separate clustering of elements in block [D] and [C].

This is illustrated using the example of previous section Using A1=S2+S4, A2=S3+S4 in this example. Total area for this example after the optimization is 9SA+4T=22 Units*. This, when combined with optimization(a) results in an area-gain of 37% in area (of coefficient design block) for this example design as compared to existing implementation (where area was 35 units).

The optimization(c) as described before can be further applied to cluster [D]. That is beside optimization(a) and optimization(b), the technique of realizing the coefficient value using subtraction (SS) instead of addition(SA) is used here. This substantially saves in area when the coefficient value is close to power of 2. (e.g., for realization of coefficient value 63, the realization (63=64 −1) is better than (63=32+16+8+4+2+1). In the first case, the number of subtractors is 1 while in the second case the number of adders are 5.). The two cases are illustrated in the previous section and are shown in FIG. 12 and FIG. 9 of the drawings. The area calculation without optimization and using adders (FIG. 9 of the drawings) equals 29 Units*, while optimization applied to FIG. 12 of the drawings results in an area of 22 Units*. This is an improvement by 24% in reducing area of coefficient block for this example.

With all the optimization applied, the invention while in use results in an area improvement of 30-50% of the coefficient block design or combinational logic consisting of adders, subtractor, multiplier and unit delays [T].

*Note that the input to adders in [B] are interchangeable e.g., adders SA(5), SA(6) inputs could be interchanged. Also the signals t_{—}1, t_{—}2 etc. can be connected to any input of adders of block [B] of next bit position.

**For approximate area calculation following assumption is made (1 Unit of Area=1 FA=2HA=1T & SA=SS=2 Units of Area).

The present invention is most economical in terms of area of coefficient block/architecture. In fact, the present invention provides an area improvement of 30-50% of the coefficient block design or combinational logic consisting of adders, subtractor, multiplier and unit delays.

From the foregoing it will be appreciated that, although specific embodiments of the invention have been described herein for purposes of illustration, various modifications may be made without deviating from the spirit and scope of the invention. Accordingly, the invention is not limited except as by the appended claims and the equivalents thereof.

1. A device for providing an area efficient implementation of coefficient processing hardware for a filter, the device comprising: an architecture [A] with hardware sharing techniques and optimization applied to this architecture, the architecture [A] coupled coefficient input bit lines both to perform a filtering operation or a mathematical computing operation with a zero latency output, the architecture [A] having serial coefficient input bit lines S1, S2 . . . . Sn, where n represents the number of coefficients of the filter, and addition terms of an equation [(a0*S1+b0*S2+ . . . +k0*Sn), (a1*S1+b1*S2+ . . . +k1*Sn) . . . (am*S1+bm*S2+ . . . +km*Sn)] are represented as blocks [B], the values of a0, b0 . . . etc are represented as (+/−)1 or 0, each block [B] formed as a combinational-sequential block comprising serial adders circuits (SA) and serial subtractor circuits (SS), the connection of the SA and SS circuits to S1, S2 . . . Sn lines and interconnection of the SA and SS circuits depend dependent on a value of the coefficients, the SA and SS circuits arranged in matrix form with SA0_{—}0 to SA0_n in bit position 0 and SA1_{—}1 to SA1_n in bit position 1 and similarly SAm_{—}1 to Sam_n in bit position m, an output of each block [B] is connected to a respective unit delay element [T] through respective lines b 1, b_{—}2, . . . b_m, the number of delay elements [T] depend on a value of a maximum coefficient and is shareable for all coefficients in the coefficient architecture [A], an output of delay element [T] is connected to one input of a combinational logic of block [B] of a next bit position of block [B] depending upon a sign value in the said architecture [A] all the SA and SS circuits in block [B] clustered together as a block [D] and all the unit delay elements {T[1], T[2] . . . T[m]} are clustered together in a sequential block [C], thereby separating the combinational-sequential, block [B], and the sequential logical block [C], while in the architecture [A] the sequential unit delay elements [T] of block [C] are common for all the coefficients and are shareable and positioned at an end position of each block [B], and the block [D] has combinational-sequential blocks [B] that are essentially SA, and SS circuits in hardware within block [D] that are shareable, and a final output of architecture [A] is taken from an output a block [B] at a last bit position.

2. The device of claim 1 wherein the when operated in bit serial fashion, the architecture [A] provides hardware minimization for finite impulse response (FIR) filter, infinite impulse response filter (IIR), and for other applications related to combination logic having delay element (T), multiplier (M), adder (SA) and subtractor (SS).

3. The device as of claim 1, comprising further optimization in block [D]by using common adders (SA) and common subtractors (SS) in block [B] with shared outputs.

4. The device of claim 1, comprising further optimization in block [D] by using a subtractor (SS) instead of an adders (SA), when a coefficient value is closer to a power of two.

5. The device of claim 1, comprising further optimization in block [D] by minimizing the use of a subtractor (SS) by taking a common subtraction operator and using an adder instead.

6. (canceled)

7. A coefficient block for a digital filter including:
(a) m+1 combinational-sequential logic circuits, B0, B1, . . . , Bm, where B0 produces output b_{—}1, B1 produces output b_{—}2, . . . , Bm-1 produces output B_m and Bm produces an output of the coefficient block;
(b) n serial input data lines S1, S2, . . . , Sn, where n is the number of coefficients of the digital filter; and
(c) m unit delay elements, T(1), T(2), . . . , T(m), where m is the number of bits in an input bit stream of the coefficient block at any given time;
where B0 receives input from a first one of the n serial input data lines and effects output b_{—}1, T(1) receives b_{—}1 as input and effects a unit delayed output t_{—}1, B 1 receives input from a second one of the n serial input data lines and from T(1) and effects output b_{—}2, T(2) receives b_{—}2 as input and effects a unit delayed output t_{—}2, . . . , and Bm receives input from a first one of the n serial input data lines and from T(m) and effects the output of the coefficient block.

8. The coefficient block of claim 1 where the m+1 combinational-sequential logic circuits B0, B 1, . . . , Bm can be represented as:
[(a0*s1+b0*s2+ . . . +k0*sn),(a1*s1+b1*s2+ . . . +k1*sn), . . . ,(am*s1+bm*s2+ . . . +km*sn)]
wherein each of the coefficients, a, b, . . . , k, for a combinational-sequential logic circuit are equal to +/−1, 0.

9. The coefficient block of claim 7 wherein each combinational-sequential logic circuit includes a first plurality of serial adders and a second plurality of serial subtractors, and where connectivity of each serial adder and serial subtractor to the serial input data lines in a combinational-sequential logic circuit is dependent on a value of the coefficients in the set of coefficients for the combinational-sequential logic circuit.

10. A coefficient processing circuit for processing coefficients in a bit serial format having n bit positions, the circuit comprising:
a plurality of serial input bit lines to receive coefficient values;
a combinational-sequential circuit comprising n combinational-sequential blocks, each combinational-sequential block coupled to at least one of the plurality of serial input bit lines, each combinational-sequential block comprising at least one serial adder and an output; and
an output circuit coupled to the combinational-sequential circuit and configured to receive the output of each combinational-sequential block, the output circuit comprising multiplier circuits for bit positions 0 through n−1, respectively, each multiplier circuit having an input coupled to the output of the combinational-sequential block occupying the corresponding bit position, each multiplier circuit further having an output coupled to an input of the combinational-sequential block occupying the next higher bit position, and the output of the combinational-sequential block in the n bit position comprising an output of the circuit.

11. The circuit of claim 10 wherein at least one of the combinational-sequential blocks comprises a serial subtractor.

12. The circuit of claim 10 wherein the multiplier circuits comprise a flip-flop configured as a multiplier-by-two circuit.

13. A coefficient processing circuit for processing coefficients in a bit serial format have five bit positions, the circuit comprising:
first, second, third, and fourth serial input lines;
a combinational-sequential circuit comprising first, second, third, and fourth serial adder blocks corresponding to bit positions 0 through 4, respectively, each serial adder block coupled to at least two of the serial input lines and having an output; and
an output circuit coupled to the combinational-sequential circuit and comprising first, second, third, and fourth multiplier circuits each having an input coupled to a respective output of the serial adder block of the corresponding bit position 0 through 3, and each multiplier circuit having an output coupled to the serial adder block occupying the next higher bit position, with the output of the fifth serial adder block comprising an output of the circuit.

14. A coefficient processing circuit for processing coefficients in a bit serial format have five bit positions, the circuit comprising:
first, second, third, and fourth serial input lines;
a combinational-sequential circuit comprising first, second, third, and fourth serial adder blocks corresponding to bit positions 0 through 4, respectively, the first serial adder block having a first serial adder with a first input coupled to the third serial input line and a second input coupled to the fourth serial input line and an output comprising the output of the first serial adder block, the second serial adder block having a second serial adder with a first input coupled to the second serial input line and a second input coupled to the third serial input line and an output that is coupled to an input of a second serial adder that has a second input coupled to the fourth serial input line and an output that is coupled to a first input of a third serial adder that has an output comprising the output of the second serial adder block, the third serial adder block comprising a fifth serial adder having a first input coupled to the first serial input line and a second input coupled to the second serial input line and an output that is coupled to a first input of a sixth serial adder having a second input coupled to the fourth serial input line and an output that is coupled to an input of a seventh serial adder having an output that forms the output of the third serial adder, the fourth serial adder block comprising an eighth serial adder having a first input coupled to the second serial input line and a second input coupled to the fourth serial input line and an output coupled to a first input of a ninth serial adder having an output that comprises the output of the fourth serial adder block, the fifth serial adder block comprising a tenth serial adder having a first input coupled to the first serial input line and a second input coupled to the third serial input line and an output coupled to a first input of an eleventh serial adder having an output comprising the output of the fifth serial adder block.

15. The circuit of claim 14 wherein the output of the first multiplier circuit is coupled to the second input of the fourth serial adder in the second serial adder block, the output of the second multiplier circuit is coupled to the second input of the seventh serial adder in the third serial adder block, the output of the third multiplier circuit coupled to the second input of the ninth serial adder in the fourth serial adder block, and the output of the fourth multiplier circuit coupled to the second input of the eleventh serial adder in the fifth serial adder block.

16. A coefficient processing circuit for processing coefficients in a bit serial format have five bit positions, the circuit comprising:
first, second, third, and fourth serial input lines;
a combinational-sequential circuit comprising first, second, third, and fourth serial adder blocks corresponding to bit positions 0 through 4, respectively, an input coupled to an output of the first serial adder, and an output coupled to a first input of a third serial adder having an output that comprises the output of the second serial adder block, the third serial adder block comprising a third serial adder having a first input coupled to the first serial input line and an output coupled to a first input of a fifth serial adder having an output that comprises the output of the third serial adder block, the fourth serial adder block comprising a sixth serial adder having a first input coupled to the second serial input line and a second input coupled to the fourth serial input line and an output coupled to a second input of the fifth serial adder and further coupled to a first input of a seventh serial adder having an output that comprises the output of the fourth serial adder block, the fifth serial adder block comprising an eighth serial adder having a first input coupled to the first serial input line and a second input coupled to the third serial input line and an output coupled to a first input of a ninth serial adder having an output that comprises the output of the fifth serial adder block.

17. The circuit of claim 16 wherein the output of the first multiplier circuit is coupled to a second input of the third serial adder in the second serial adder block, the output of the second multiplier circuit coupled to a second input of the fifth serial adder in the third serial adder block, the output of the third multiplier circuit coupled to a second input of the seventh serial adder in the fourth serial adder block, and the output of the fourth multiplier circuit coupled to a second input of the ninth serial adder block.

18. A coefficient processing circuit for processing coefficients in a bit serial format having six bit positions, the circuit comprising:
first, second, third, and fourth serial input lines;
a combinational-sequential circuit comprising first, second, third, fourth, and fifth combinational-sequential blocks, the first combinational-sequential block comprising a first adder having a first input coupled to the third serial input line and an output comprising an output of the first combinational-sequential block, the second combinational-sequential block comprising a first serial subtractor having a first input coupled to the second serial input line and an output coupled to a first input of a second serial subtractor having a second input coupled to the third serial input line and an output comprising an output of the second combinational-sequential block, the third combinational-sequential block comprising a second serial adder having a first input coupled to the second serial input line and an output comprising an output of the third combinational-sequential block, the fourth combinational-sequential block comprising a third serial adder having a first input coupled to the first serial input line and an output comprising an output of the fourth combinational-sequential block, and the fifth combinational-sequential block comprising a fourth serial adder having a first input coupled to the fourth serial input line and an output coupled to a first input of a fifth serial adder having a second input coupled to an output of a sixth serial adder having a first input coupled to the first serial input line and a second input coupled to the second serial input line, the fifth serial adder having an output comprising an output of the fifth combinational-sequential block; and an output circuit coupled to the combinational-sequential circuit and comprising first, second, third, fourth, fifth, and sixth multiplier circuits, the first multiplier circuit having an input coupled to the fourth serial input line and an output coupled to a second input of the first serial adder, the second multiplier circuit having an input coupled to the output of the first combinational-sequential block and an output coupled to a second input of the first serial subtractor in the second combinational-sequential block, the third multiplier circuit having an input coupled to the output of the second combinational-sequential block and an output coupled to a second input of the second serial adder in the third combinational-sequential block, the fourth multiplier circuit having an input coupled to the output of the third combinational-sequential block and an output coupled to a second input of the third serial adder in the fourth combinational-sequential block, the fifth multiplier circuit having an input coupled to the output of the fourth combinational-sequential block and an output coupled to an input of the sixth multiplier circuit, an output that is coupled to a second input of the fourth serial adder in the fifth combinational-sequential block.
